(19) United States
(12) Patent Application Publication
(10) Pub. No.: US 2023/0065761 A1
(43) Pub. Date: Mar. 2, 2023

(54) REMOTE DRIVER SUPPORT METHOD, REMOTE DRIVER SUPPORT SYSTEM, AND STORAGE MEDIUM

(71) Applicant: TOYOTA JIDOSHA KABUSHIKI KAISHA, Toyota-shi (JP)

(72) Inventors: Hideki FUKUDOME, Toyota-shi (JP); Kosuke AKATSUKA, Mishima-shi (JP); Myu UEHARA, Nisshin-shi (JP); Tsukasa KITO, Aisai-shi (JP); Satoshi OMI, Ebina-shi (JP); Yuki NISHIKAWA, Susono-shi (JP)

(73) Assignee: TOYOTA JIDOSHA KABUSHIKI KAISHA, Toyota-shi (JP)

(21) Appl. No.: 17/805,947

(22) Filed: Jun. 8, 2022

(30) Foreign Application Priority Data
Aug. 24, 2021 (JP) 2021-136619

(51) Int. Cl. B60W 50/14; B60W 40/12; B60W 40/06; G05D 1/00; G06V 20/56

(52) U.S. Cl. CPC B60W 50/14; B60W 40/12; B60W 40/06; G05D 1/0038; G05D 1/0044; G06V 20/56; B60W 2050/146; B60W 2420/42; B60W 2530/201; B60W 2556/40; G05D 2201/0213

(57) ABSTRACT

A remote driver support method according to the present disclosure includes: acquiring vehicle dimension information related to a dimension of a vehicle that is remotely driven by a remote driver, and acquiring road structure information related to a structure of a road ahead to which the vehicle is heading. The remote driver support method according to the present disclosure further includes: generating passability information related to a possibility that the vehicle is able to pass through the road ahead based on the vehicle dimension information and the road structure information; and notifying the remote driver of the passability information.

### CROSS-REFERENCE TO RELATED APPLICATION

This application claims priority to Japanese Patent Application No. 2021-136619 filed on Aug. 24, 2021, incorporated herein by reference in its entirety.

### BACKGROUND

### 1. Technical Field

The present disclosure relates to a remote driver support method, a remote driver support system, and a storage medium storing a program that causes a computer to perform remote driver support.

### 2. Description of Related Art

Remote driving performed through a screen of a monitor makes it difficult to understand the sense of distance. Japanese Unexamined Patent Application Publication No. 2020-058003 (JP 2020-058003 A) discloses an example of a solution to this issue. The technique disclosed in JP 2020-058003 A is to display the distance from a vehicle to an object around the vehicle on the screen of a monitor for a remote driver.

It is also not easy for the remote driver to understand the size of a vehicle that is being remotely driven. For this reason, in the remote driving system of the related art, it is not possible to correctly determine whether the vehicle that is driven remotely can pass through the road ahead, which may hinder continuation of remote driving.

### SUMMARY

The present disclosure has been made in view of the above-mentioned issues. An object of the present disclosure is to provide a technique that can support a remote driver by providing information useful for determining whether a vehicle can pass through the road ahead.

The present disclosure provides a remote driver support method. The remote driver support method according to the present disclosure includes: acquiring vehicle dimension information related to a dimension of a vehicle that is remotely driven by a remote driver; and acquiring road structure information related to a structure of a road ahead to which the vehicle is heading. The remote driver support method according to the present disclosure further includes: generating passability information related to a possibility that the vehicle is able to pass through the road ahead based on the vehicle dimension information and the road structure information; and notifying the remote driver of the passability information.

The remote driver support method according to the present disclosure may further include notifying the remote driver of the vehicle dimension information and the road structure information together with the passability information. Further, the notifying the remote driver of the passability information may include changing a color of at least a part of a screen viewed by the remote driver corresponding to a magnitude of passability, and may include numerically displaying a degree of margin of a dimension of the road ahead with respect to the dimension of the vehicle on the screen viewed by the remote driver.

The remote driver support method according to the present disclosure may further include selecting the road ahead from among a plurality of roads in accordance with an operation direction of a turn signal by the remote driver. Further, the remote driver support method according to the present disclosure may further include determining the road ahead to which the remote driver intends to be heading based on a steering angle of a steering wheel by the remote driver.

The remote driver support method according to the present disclosure may further include: displaying a view in front of the vehicle on a screen viewed by the remote driver; and displaying an image showing the dimension of the vehicle on the screen. In addition, the remote driver support method according to the present disclosure may further include: displaying an image of the road ahead in a plan view or in a bird's-eye view on the screen viewed by the remote driver; and displaying an image showing a simulation result of a possible traveling locus of the vehicle on the image of the road ahead.

In the remote driver support method according to the present disclosure, the acquiring the road structure information may include acquiring the road structure information from high-precision three-dimensional map data, and the acquiring the road structure information may include acquiring the road structure information using an environment recognition sensor mounted on the vehicle.

The present disclosure provides a remote driver support system. The remote driver support system according to the present disclosure includes: at least one memory that stores at least one program; and at least one processor connected to the at least one memory. The at least one program is configured to cause the at least one processor to perform the following processes. A first process is to acquire vehicle dimension information related to a dimension of a vehicle that is remotely driven by a remote driver. A second process is to acquire road structure information related to a structure of a road ahead to which the vehicle is heading. A third process is to generate passability information related to a possibility that the vehicle is able to pass through the road ahead based on the vehicle dimension information and the road structure information. A fourth process is to notify the remote driver of the passability information.

The present disclosure provides a storage medium storing a program that causes a computer to perform support for the remote driver. The program according to the present disclosure is configured to cause the computer to perform the following processes. A first process is to acquire vehicle dimension information related to a dimension of a vehicle that is remotely driven by the remote driver. A second process is to acquire road structure information related to a structure of a road ahead to which the vehicle is heading. A third process is to generate passability information related to a possibility that the vehicle is able to pass through the road ahead based on the vehicle dimension information and the road structure information. A fourth process is to notify the remote driver of the passability information.

The remote driver support method, the remote driver support system, and the storage medium can support the remote driver by providing information useful for determining whether the vehicle can pass through the road ahead.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a remote driving device and a first case in which support for a remote driver is required;

FIG. 2 is a diagram illustrating an outline of a remote driver support method in the first case;

FIG. 3 is a diagram illustrating an outline of a remote driver support method in the first case;

FIG. 4 shows a display example of the screen of a display device in the first case;

FIG. 5 is a diagram illustrating a second case in which support for the remote driver is required;

FIG. 6 is a diagram illustrating an outline of the remote driver support method in the second case;

FIG. 7 shows a first display example of the screen of the display device in the second case;

FIG. 8 shows a second display example of the screen of the display device in the second case;

FIG. 9 is a diagram illustrating a third case in which support for the remote driver is required;

FIG. 10 is a diagram illustrating an outline of the remote driver support method in the third case;

FIG. 11 shows a display example of the screen of the display device in the third case;

FIG. 12 is a flowchart showing a procedure of the remote driver support method according to an embodiment of the present disclosure; and

FIG. 13 is a diagram showing a configuration example of a remote driver support system according to the embodiment of the present disclosure.

### DETAILED DESCRIPTION OF EMBODIMENTS

Hereinafter, an embodiment of the present disclosure will be described with reference to the drawings. However, when the number, quantity, amount, range, etc. of each element are referred to in the embodiment shown below, the idea of the present disclosure is not limited to the numbers mentioned herein except when explicitly stated or when clearly specified by the number in principle. In addition, the structures and the like described in the embodiment shown below are not necessarily essential to the idea of the present disclosure, except when explicitly stated or when clearly specified in principle.

### 1. Configuration of Remote Driving Device

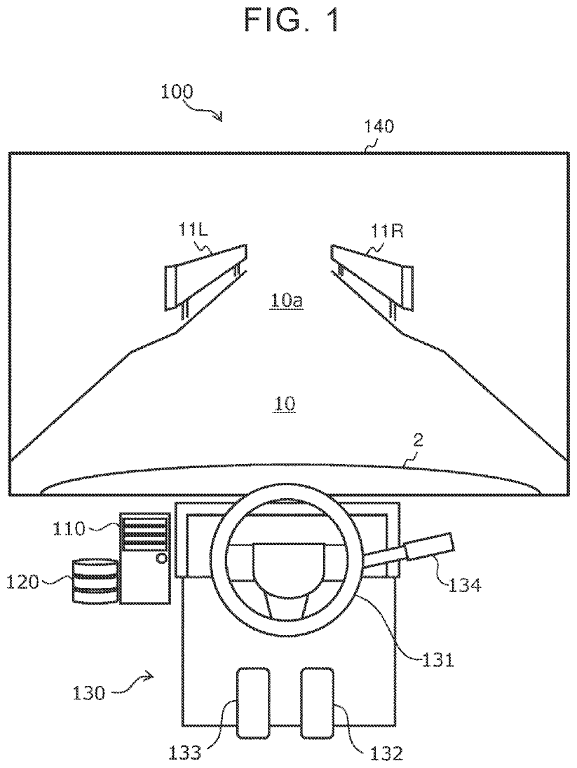

A support method according to the present embodiment is a method of supporting a remote driver. The remote driver operates a remote driving device at a position away from a vehicle. The remote driving device provides the remote driver with information related to driving and receives operations by the remote driver. An example of the configuration of the remote driving device is shown in FIG. 1. A remote driving device 100 shown in FIG. 1 includes an information processing device 110, a data storage device 120, a driving operation device 130, and a display device 140.

The information processing device 110 is a device that executes processes related to remote driving. The information processing device 110 includes at least one processor and at least one memory connected to the processor. The memory stores a program that can be executed by the processor. The memory includes a main storage device and an auxiliary storage device. The program can be stored in the main storage device or in a computer-readable recording medium including the auxiliary storage device. The program stored in the memory includes a program causing the information processing device 110 that is a computer to perform support of the remote driver that will be described later. The program may be provided via a network.

The data storage device 120 is a device that stores high-precision three-dimensional map data. The high-precision three-dimensional map data includes road structure information, for example, information such as a road width, a curvature, a step, and the ceiling height of a tunnel section. The data storage device 120 may be an external storage device attached to the information processing device 110, or may be a data server connected to the information processing device 110 via the network. In any case, the high-precision three-dimensional map data stored in the data storage device 120 is updated to the latest data at any time. The information processing device 110 can access the data storage device 120 and acquire necessary road structure information from the high-precision three-dimensional map data.

The information processing device 110 is configured to be able to mutually exchange information with the driving operation device 130 and the display device 140. Typically, the information processing device 110, and the driving operation device 130 and the display device 140 are physically connected by a communication cable. However, the information processing device 110 may be a server connected to the driving operation device 130 and the display device 140 via a network. Further, the information processing device 110 is configured to communicate with the vehicle and transmit and receive information to and from the vehicle. Communication between the information processing device 110 and the vehicle is performed using the network including mobile communication.

Further, the information processing device 110 executes a process related to a display of the display device 140. That is, in the remote driving device 100 shown in FIG. 1, the information processing device 110 also functions as a display processing device. The information processing device 110 transmits a display signal to the display device 140. The display signal transmitted to the display device 140 includes a signal for displaying a traveling image acquired from a camera mounted on the vehicle and a signal for displaying support information for supporting the remote driver.

The display device 140 performs display in accordance with the display signal acquired from the information processing device 110. The display device 140 is typically a display device such as a liquid crystal display or an organic electro-luminescence (EL) display. However, the display device 140 may be another device having an appropriate display function. Further, the display device 140 may be a system composed of a plurality of devices. For example, the display device 140 may be a multi-display system configured by connecting a plurality of display devices. At least the traveling image of the vehicle and the support information for supporting the remote driver are displayed on the screen of the display device 140.

The driving operation device 130 is a device that receives an operation by the remote driver. The driving operation device 130 shown in FIG. 1 includes a steering wheel 131 for receiving a steering operation, an accelerator pedal 132 for receiving an acceleration operation, a brake pedal 133 for receiving a braking operation, and a turn signal 134 for receiving a direction indication operation. The operation signal received by the driving operation device 130 is transmitted to the vehicle via the information processing device 110.

### 2. Remote Driver Support Method

### 2-1. Issue in Remote Driving

The remote driver understands the situation around the vehicle by visually checking the screen of the display device 140, and operates the driving operation device 130 as appropriate. With the above, remote driving by the remote driver is performed. However, in remote driving while the remote driver is looking at the screen of the display device 140, it is difficult for the remote driver to understand the size of the vehicle. Without understanding of the size of the vehicle, the remote driver cannot correctly determine whether the vehicle can pass through the road ahead.

The support method according to the present embodiment is a method of supporting the remote driver using the display of support information by the information processing device 110 such that the remote driver can easily understand the size of the vehicle on the screen of the display device 140. Hereinafter, the support method according to the present embodiment will be described by taking a specific case in which support for the remote driver is required as an example.

2-2. First Case where Support for Remote Drivers is Required

### 2-2-1. Contents of First Case

A first case in which support for the remote driver is required will be described with reference to FIG. 1. The screen of the display device 140 shown in FIG. 1 shows a road 10 extending straight ahead of a vehicle 2 that is remotely driven by the remote driver. The remote driver can confirm on the screen of the display device 140 that the width of the road 10 is wider than the width of the vehicle 2 at the current position of the vehicle 2.

A narrow portion 10a of the road 10 ahead of the vehicle 2 is displayed on the screen of the display device 140 shown in FIG. 1. The narrow portion 10a is a portion where the width of the road 10 is narrowed, and the narrow portion 10a is interposed between guardrails 11R, 11L on the right and left sides. The minimum distance between the right and left guardrails 11R, 11L is the maximum width of the vehicle that can pass through the narrow portion 10a. Therefore, the remote driver is required to determine whether the width of the vehicle 2 is narrower than the distance between the right and left guardrails 11R, 11L.

However, it is not easy for the remote driver to make the above determination visually. Of course, as the vehicle 2 approaches the narrow portion 10a, it becomes easier for the remote driver to determine whether the width of the vehicle 2 is narrower than the distance between the right and left guardrails 11R, 11L. However, when it is found that the vehicle 2 cannot pass through the narrow portion 10a after the vehicle 2 approaches the narrow portion 10a, it may be difficult to cause the vehicle 2 to make a U-turn. Further, when the difference between the width of the vehicle 2 and the distance between the right and left guardrails 11R, 11L is very small, it cannot be denied that there is a possibility that the determination as to whether the vehicle 2 can pass through the narrow portion 10a is erroneous.

### 2-2-2. Outline of Support Method in First Case

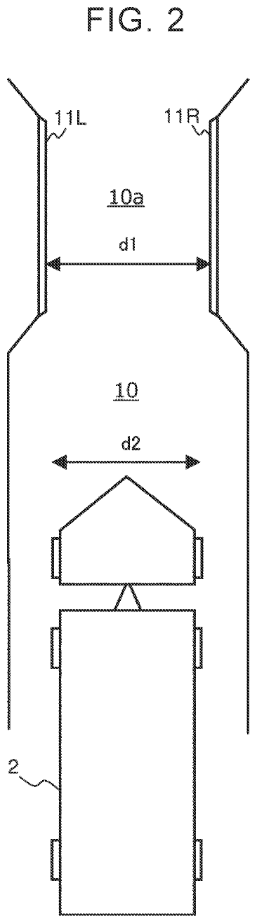

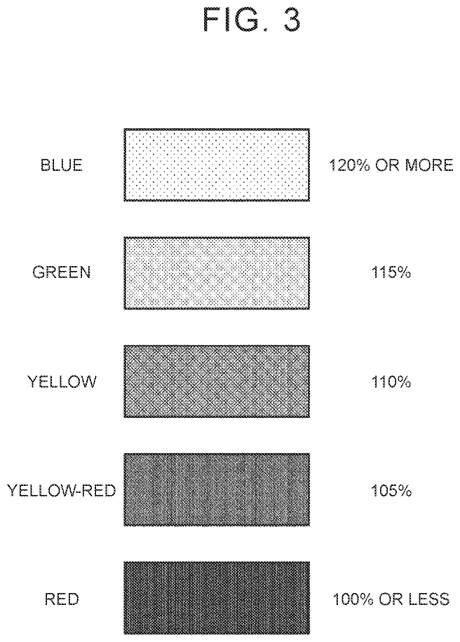

The outline of the support method in the first case will be described with reference to FIGS. 2 and 3. FIG. 2 is a plan view of the vehicle 2 on the road 10 as viewed from above. In FIG. 2, the width of the narrow portion 10a determined by the distance between the right and left guardrails 11R, 11L is described as d1, and the width of the vehicle 2 is described as d2. When the width d2 of the vehicle 2 is narrower than the width d1 of the narrow portion 10a, the vehicle 2 can theoretically pass through the narrow portion 10a. However, in consideration of wobbling in the width direction of the vehicle 2 during traveling, fluctuation of the steering operation of the remote driver, and the like, it is necessary to provide a certain margin with respect to the width d2 of the vehicle 2. On assumption that the margin is Δd2, the condition that the vehicle 2 can pass through the narrow portion 10a is d2+Δ<d1.

In the support method according to the present embodiment, the computer, that is, the information processing device 110 executes the determination of whether the condition “d2+Δd2<d1” is satisfied on behalf of the remote driver. Vehicle dimension information including the width d2 of the vehicle 2 is stored in the memory of an on-board control device of the vehicle 2. The information processing device 110 acquires the vehicle dimension information from the on-board control device when communication with the vehicle 2 is connected, and stores the vehicle dimension information in the memory of the information processing device 110. Further, the vehicle dimension information of all the vehicles subject to remote driving may be stored in a data server, and the vehicle dimension information may be read from the data server before the start of remote driving.

The width d1 of the narrow portion 10a is measured using an image of a camera mounted on the vehicle 2. The camera is, for example, a stereo camera, and is installed in a front portion of the vehicle 2, for example, in an upper portion of a windshield, with the field of view facing the front of the vehicle 2. Further, the width d1 of the narrow portion 10a may be measured using information acquired by an on-board environment recognition sensor other than the camera, for example, point cloud information acquired by light detection and ranging (LIDAR), or the width d1 of the narrow portion 10a may be measured using information acquired by multiple environment recognition sensors including the camera.

In the support method according to the present embodiment, the width d1 of the narrow portion 10a can also be acquired from the high-precision three-dimensional map data stored in the data storage device 120. In this case, the information processing device 110 acquires position information from the vehicle 2 and specifies the position of the vehicle 2 on the map. The position information of the vehicle 2 is acquired by self-position estimation using the global positioning system (GPS) or an environment recognition sensor. The information processing device 110 searches for high-precision three-dimensional map data corresponding to the position of vehicle 2 on the map, and acquires road structure information around the vehicle 2 from the high-precision three-dimensional map data. The width d1 of the narrow portion 10a is included in the road structure information.

The margin Δd2 is stored in the memory of the information processing device 110. As an example, the margin Δd2 is set to the minimum necessary value for the average remote driver to pass through the road ahead without any problem. However, the margin Δd2 may be set for each remote driver in consideration of the difference in skill of each remote driver. For example, the margin Δd2 may be set smaller for a highly skilled remote driver in remote driving, and the margin Δd2 may beset larger for an unskilled remote driver in remote driving. In that case, the margin Δd2 for each remote driver may be stored in the data server, and the margin Δd2 may be read from the data server before the start of remote driving.

The information processing device 110 generates passability information related to a possibility that the vehicle 2 can pass through the narrow portion 10a based on the determination result of whether the condition “d2+Δd2<d1” is satisfied. The passability information includes a degree of margin when the vehicle 2 can pass through the narrow portion 10a, in addition to whether the vehicle 2 can pass through the narrow portion 10a. The degree of margin is represented by the width d1 of the narrow portion 10a with respect to the width d2+Δd2 of the vehicle 2 including the margin d2. That is, the degree of margin is represented by d1/(d2+Δd2).

In the support method according to the present embodiment, the remote driver is visually notified of the passability information by displaying the passability information on the screen of the display device 140. Specifically, a color of at least a part of the screen of the display device 140 is changed corresponding to the magnitude of the degree of margin such that the remote driver can visually recognize the degree of margin. That is, in the support method according to the present embodiment, the screen color that is changed corresponding to the magnitude of the degree of margin is used as the passability information.

FIG. 3 is a diagram showing an example of a method of displaying the passability information. In the example shown in FIG. 3, when the degree of margin is 100% or less, that is, when the vehicle 2 cannot pass through the narrow portion 10a, the display color is red. On the other hand, when the degree of margin is 120% or more, that is, when there is no problem for the vehicle 2 to pass through the narrow portion 10a, the display color is blue. When the degree of margin is larger than 100% and smaller than 120%, the display colors of green, yellow, and yellow-red are used in descending order of the degree of margin. Note that, the display colors illustrated in FIG. 3 follow the definition of safety colors of the Japanese Industrial Standards (JIS). However, as long as the remote driver can visually recognize the magnitude of the degree of margin, other colors may be used.

Further, in the support method according to the present embodiment, the numerical value of the degree of margin itself is displayed on the screen, in addition to that the display color of the screen is changed corresponding to the degree of margin. In the next section, a specific example of the screen display of the display device 140 will be described with reference to the drawings.

### 2-2-3. Screen Display of Display Device in First Case

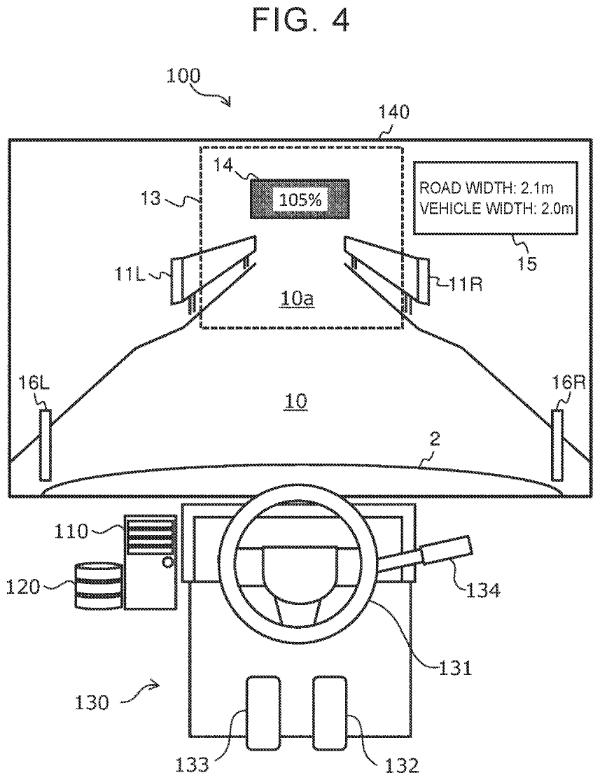

FIG. 4 shows a display example of the screen of the display device 140 in the first case. An indicator 14 indicating the degree of margin of the narrow portion 10a is displayed on the screen of the display device 140 by applying the support method according to the present embodiment. The position where the indicator 14 is displayed is near the narrow portion 10a and at a position where the indicator 14 does not obstruct the field of view of the remote driver. The display color of the indicator 14 is changed corresponding to the degree of margin, and the numerical value of the degree of margin is displayed in the indicator 14. That is, the indicator 14 itself has a meaning as the passability information. Note that, in the example shown in FIG. 4, since the degree of margin is 105%, the display color of the indicator 14 is yellow-red.

Further, on the screen of the display device 140, an information display portion 15 is displayed at the same time as when the indicator 14 is displayed. The vehicle dimension information and the road structure information that are the basis for calculating the degree of margin are displayed in the information display portion 15 in characters (numerical values). Here, the vehicle dimension information is the vehicle width of the vehicle 2, and the road structure information is the road width of the narrow portion 10a. The vehicle width of the vehicle 2 may be a value including a margin or a value not including a margin. The vehicle dimension information and the road structure information are displayed on the screen together with the indicator 14 as the passability information, whereby the remote driver can accurately determine whether the vehicle 2 can pass through the narrow portion 10a.

Further, in the example shown in FIG. 4, a frame line 13 is displayed in front of the vehicle 2. The frame line 13 is a simplified image showing the dimensions of the vehicle 2. The width of the frame line 13 indicates the vehicle width of the vehicle 2, the height of the upper side of the frame line 13 indicates the vehicle height of the vehicle 2, and the height of the lower side of the frame line 13 indicates the minimum ground clearance of the vehicle 2. The position of the frame line 13 that is an image of the vehicle 2 is the position of the vehicle 2 in the future by a predetermined time, and is calculated from the vehicle speed and the steering angle. The remote driver can accurately determine whether the vehicle 2 can pass through the narrow portion 10a by confirming the positional relationship between a road structural object, such as the guardrails 11R, 11L, and the frame line 13.

Further, in the example shown in FIG. 4, images of two poles 16R, 16L are displayed on the right and left sides of the tip portion of the vehicle 2. The poles 16R, 16L are also information for supporting the remote driver. The pole 16L on the left side indicates the left end of the vehicle 2 at the current position, and the pole 16R on the right side indicates the right end of the vehicle 2 at the current position. When the vehicle 2 passes through the narrow portion 10a, the vehicle 2 is steered while the remote driver checks the positions of the poles 16R, 16L with respect to the guardrails 11R, 11L, thereby suppressing the vehicle 2 from coming into contact with the guardrails 11R, 11L.

2-3. Second Case where Support for Remote Drivers is Required

### 2-3-1. Contents of Second Case

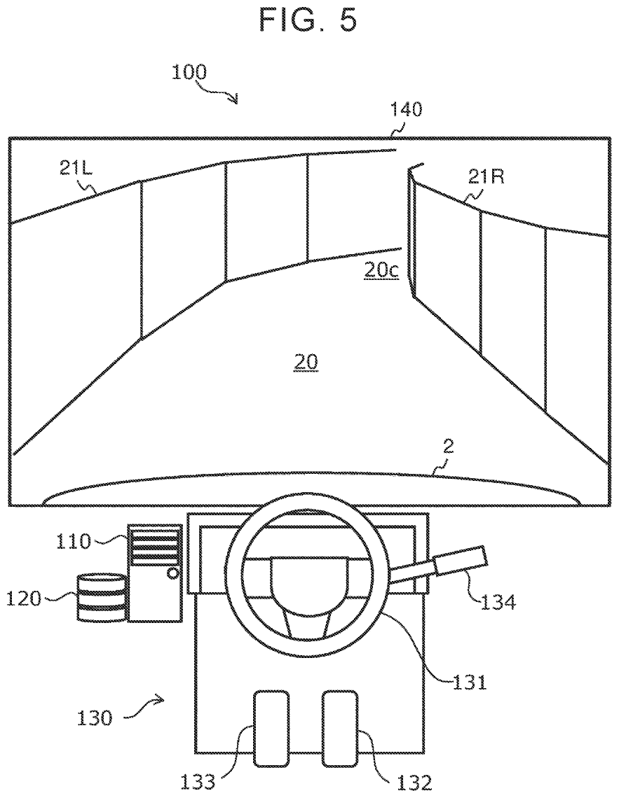

A second case in which support for the remote driver is required will be described with reference to FIG. 5. The screen of the display device 140 shown in FIG. 5 shows a road 20 that is curved to the right in front of the vehicle 2 that is remotely driven by the remote driver. The remote driver can confirm on the screen of the display device 140 that the width of the road 20 is wider than the width of the vehicle 2 at the current position of the vehicle 2.

The screen of the display device 140 shown in FIG. 5 shows that high walls 21R, 21L stand on the right and left sides of the road 20. Therefore, the remote driver cannot view the depth of a curved portion 20c of the road 20 from the current position of the vehicle 2. Accordingly, the remote driver cannot determine from the screen what the road 20 looks like behind the curved portion 20c with poor visibility and whether the road width through which the vehicle 2 can pass is maintained.

In the example shown in FIG. 5, the remote driver can view the depth of the curved portion 20c only after the vehicle 2 turns along the curved portion 20c. However, when it is found that there is a place through which the vehicle 2 cannot pass after the vehicle 2 turns along the curved portion 20c, it may be difficult to cause the vehicle 2 to make a U-turn. Further, when a curve with poor visibility continues further beyond the curved portion 20c, there is a possibility that the remote driver cannot determine whether the road width through which the vehicle 2 can pass is maintained unless the vehicle 2 advances further. Therefore, the remote driver desires to have information for determining whether the vehicle 2 can pass beyond the curved portion 20c before the vehicle 2 reaches the curved portion 20c.

### 2-2-3. Outline of Support Method in Second Case

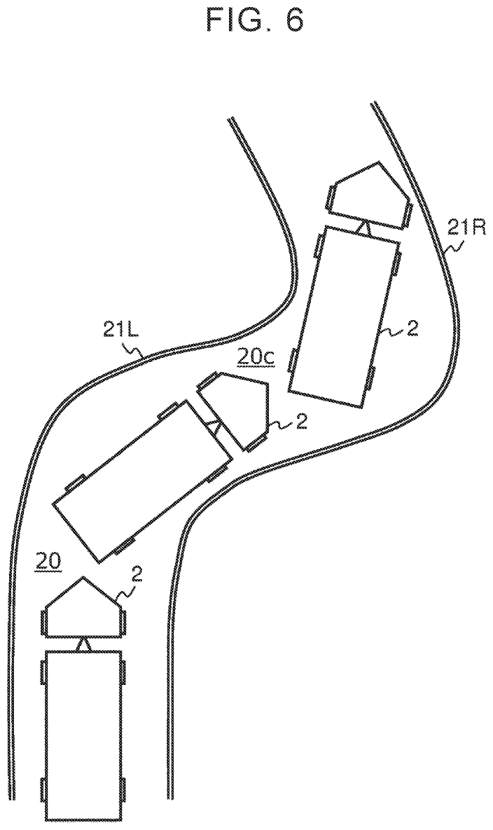

The outline of the support method in the second case will be described with reference to FIG. 6. FIG. 6 is a plan view of the vehicle 2 and the road 20 ahead of the vehicle 2 as viewed from above. When the vehicle 2 and the road 20 are viewed in the plan view as described above, it is clear at a glance what the road 20 looks like behind the curved portion 20c with poor visibility, and whether the road width through which the vehicle 2 can pass is maintained.

The plan view as shown in FIG. 6 can be acquired from the high-precision three-dimensional map data stored in the data storage device 120. The information processing device 110 acquires position information from the vehicle 2 and specifies the position of the vehicle 2 on the map. The information processing device 110 searches for the high-precision three-dimensional map data corresponding to the position of the vehicle 2 on the map, and acquires the road structure information around the vehicle 2 from the high-precision three-dimensional map data.

The information processing device 110 determines whether the vehicle 2 can pass beyond the curved portion 20c by simulating a possible traveling locus of the vehicle 2. In the simulation, for example, a method such as a rod passing problem is used. Further, the road structure information such as the width, the depth, and the curvature of the curved portion 20c and the vehicle dimension information such as the width and length of the vehicle 2 are used as simulation parameters.

As described above, in the second case, as the remote driver support method, in addition to visual notification to the remote driver of the passability information, a simulation result of the possible traveling locus of the vehicle 2 is displayed on the screen of the display device 140. In the next section, a specific example of the screen display of the display device 140 will be described with reference to the drawings.

### 2-3-3. Screen Display of Display Device in Second Case

### 2-3-3-1. First Display Example

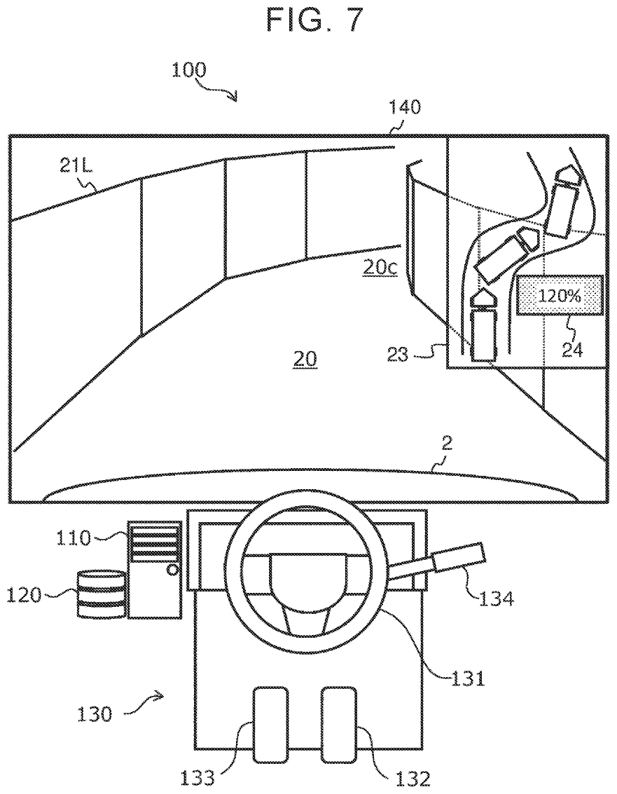

FIG. 7 shows a first display example of the screen of the display device 140 in a second case. In the first display example, the plan view is displayed in a window 23 provided in the screen. The window 23 opens on the side where the road 20 curves, that is, on the side where the state ahead of the road 20 is unseen. In the plan view in the window 23, the state of the road 20 ahead of the vehicle 2 is displayed, and further, the simulation result of the possible traveling locus of the vehicle 2 is displayed. The simulation result supports the remote driver to accurately understand the state of the road 20 ahead of the vehicle 2.

Further, in the window 23, an indicator 24 indicating the degree of margin of the road width with respect to the vehicle width is displayed. The position where the indicator 24 is displayed is near the point at which the road is narrowest in the plan view, and the degree of margin at that point is calculated. The display color of the indicator 24 is changed corresponding to the degree of margin, and the numerical value of the degree of margin is displayed in the indicator 24. In the example shown in FIG. 7, since the degree of margin is 120%, the display color of the indicator 24 is blue.

According to the first display example, the simulation result of the possible traveling locus of the vehicle 2 is displayed together with the indicator 24 indicating the degree of margin. With the above, the remote driver can accurately determine whether the vehicle 2 can pass beyond the curved portion 20c before the vehicle 2 approaches the curved portion 20c with poor visibility.

### 2-3-3-2. Second Display Example

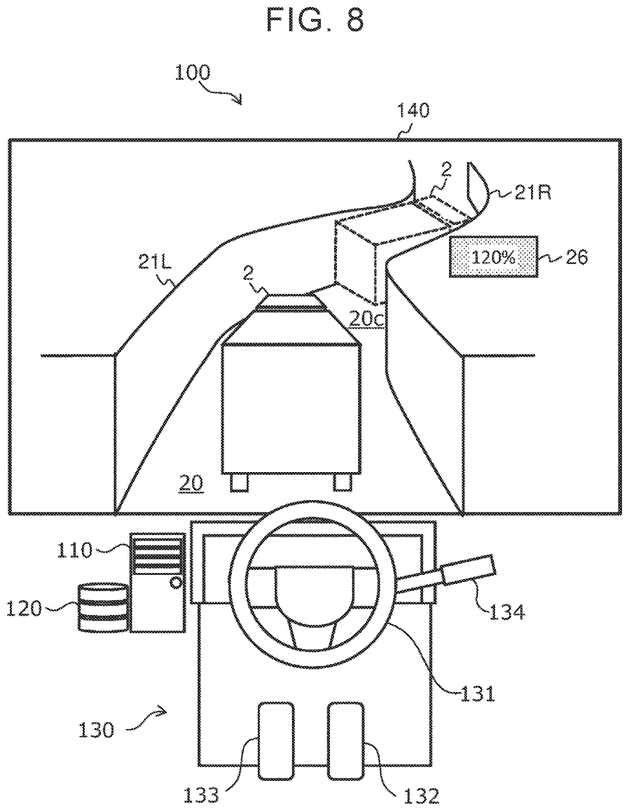

FIG. 8 shows a second display example of the screen of the display device 140 in the second case. In the first display example, the screen of the display device 140 displays the view in front of the vehicle 2 as seen from the vehicle 2. On the other hand, in the second display example, the scenery including the vehicle 2 is displayed on the screen of the display device 140 in the form of a bird's-eye view looking down the front of the vehicle 2 from above the vehicle 2.

According to the bird's-eye view as shown in FIG. 8, the remote driver can view the depth of the curved portion 20c before the vehicle 2 reaches the curved portion 20c. With the above, the remote driver can remotely drive the vehicle 2 while understanding the state of the road 20 ahead. Further, the simulation result of the possible traveling locus of the vehicle 2 is displayed on the screen of the display device 140 as shown by the dotted line in the drawing. The simulation result supports the remote driver to accurately understand the state of the road 20 ahead of the vehicle 2.

Further, an indicator 26 indicating the degree of margin of the road width with respect to the vehicle width is displayed on the screen of the display device 140. The position where the indicator 26 is displayed is near the point at which the road 20 is narrowest in the screen, and the degree of margin at that point is calculated. The display color of the indicator 26 is changed corresponding to the degree of margin, and the numerical value of the degree of margin is displayed in the indicator 26. In the example shown in FIG. 8, since the degree of margin is 120%, the display color of the indicator 26 is blue.

According to the second display example, the simulation result of the possible traveling locus of the vehicle 2 is displayed together with the indicator 26 indicating the degree of margin in the image of the road 20 ahead of the vehicle 2 displayed in the form of bird's-eye view. With the above, the remote driver can accurately determine whether the vehicle 2 can pass beyond the curved portion 20c before the vehicle 2 approaches the curved portion 20c with poor visibility.

2-4. Third Case where Support for Remote Drivers is Required

### 2-4-1. Contents of Third Case

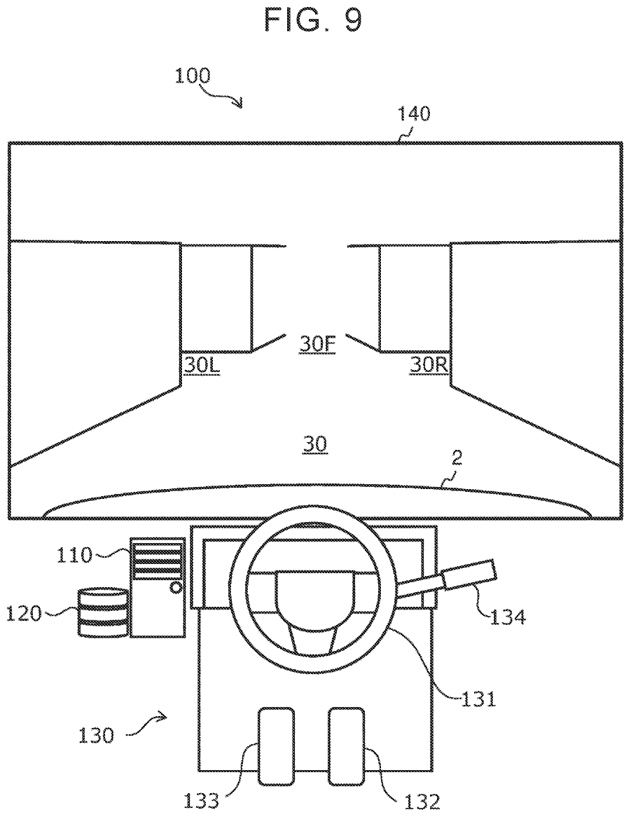

A third case in which support for the remote driver is required will be described with reference to FIG. 9. The screen of the display device 140 shown in FIG. 9 shows a road 30 that branches in three directions in front of the vehicle 2 that is remotely driven by the remote driver. The road 30 branches into a straight road 30F, a leftward road 30L, and a rightward road 30R at a junction. The remote driver can confirm on the screen of the display device 140 that the width of the road 30 is wider than the width of the vehicle 2 at the current position of the vehicle 2.

The remote driver cannot determine from the screen of the display device 140 shown in FIG. 9 what the state ahead of the straight road 30F is like and whether the road width through which the vehicle 2 can pass is maintained. Further, the remote driver cannot determine what the state ahead of the leftward road 30L is like and whether the road width through which the vehicle 2 can pass is maintained. Still further, the remote driver cannot determine what the state ahead of the rightward road 30R is like and whether the road width through which the vehicle 2 can pass is maintained.

In the example shown in FIG. 9, the remote driver can understand the state ahead of the straight road 30F only after the vehicle 2 passes through a junction and enters the straight road 30F. Further, the remote driver can understand the state ahead of the leftward road 30L only after the vehicle 2 turns left at the junction toward the leftward road 30L. Similarly, the remote driver can understand the state ahead of the rightward road 30R only after the vehicle 2 turns right at the junction toward the rightward road 30R. However, the remote driver desires to understand which of the straight road 30F, the leftward road 30L, and the rightward road 30R the vehicle 2 can pass through reliably before the vehicle 2 passes through the junction.

### 2-4-2. Outline of Support Method in Third Case

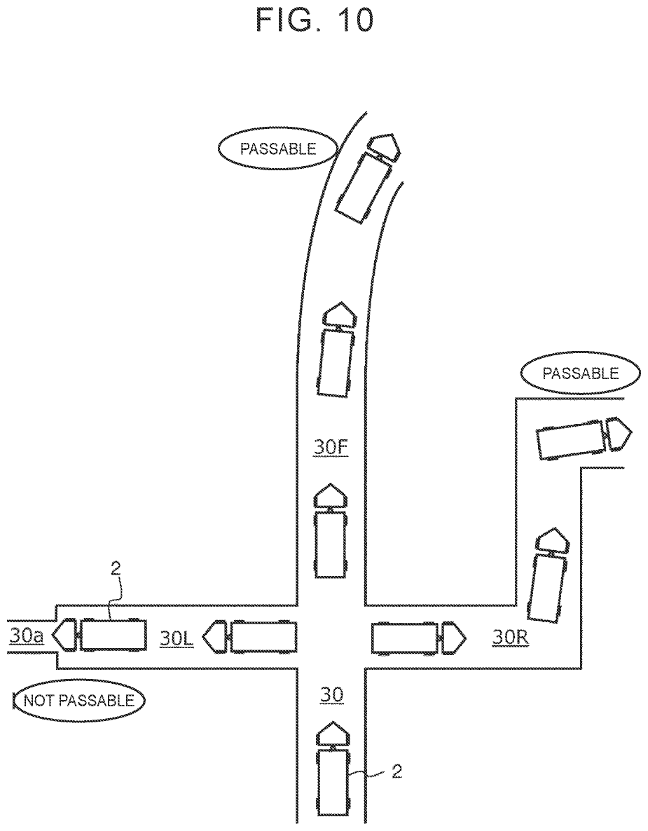

The outline of the support method in the third case will be described with reference to FIG. 10. FIG. 10 is a plan view of the vehicle 2 and the road 30 ahead of the vehicle 2 as viewed from above. When the road 30 is viewed in the plan view as described above, it is clear at a glance what the state ahead of each of the straight road 30F, the leftward road 30L, and the rightward road 30R is like, and whether the road width through which the vehicle 2 can pass is maintained. The plan view as shown in FIG. 10 can be acquired from the high-precision three-dimensional map data stored in the data storage device 120.

According to the information processing device 110, the possible traveling loci of the vehicle 2 for all of the straight road 30F, the leftward road 30L, and the rightward road 30R are simulated, and which road the vehicle 2 can reliably pass through can be calculated. However, as the number of branched roads increases, the amount of calculation becomes tremendous. Further, the remote driver who is remotely driving the vehicle 2 may not be able to understand where to check when a wide-range plan view as shown in FIG. 10 is presented. In addition, excessive provision of information may hinder concentration of the remote driver on driving.

Therefore, in the third case, as the remote driver support method, first, a display of intention related to the traveling direction issued by the remote driver is detected. The display of intention of the remote driver can be detected, for example, from the operation direction of the turn signal 134. Further, it is also possible to detect the display of intention related to the direction in which the remote driver is going to move based on the steering angle of the steering wheel 131 by the remote driver. Then, the road in the direction for which the remote driver indicates the intention is selected as the road ahead to which the vehicle 2 is heading, and the remote driver is visually notified of only the passability information of the corresponding road ahead. In the next section, a specific example of the screen display of the display device 140 will be described with reference to the drawings.

### 2-4-3. Screen Display of Display Device in Third Case

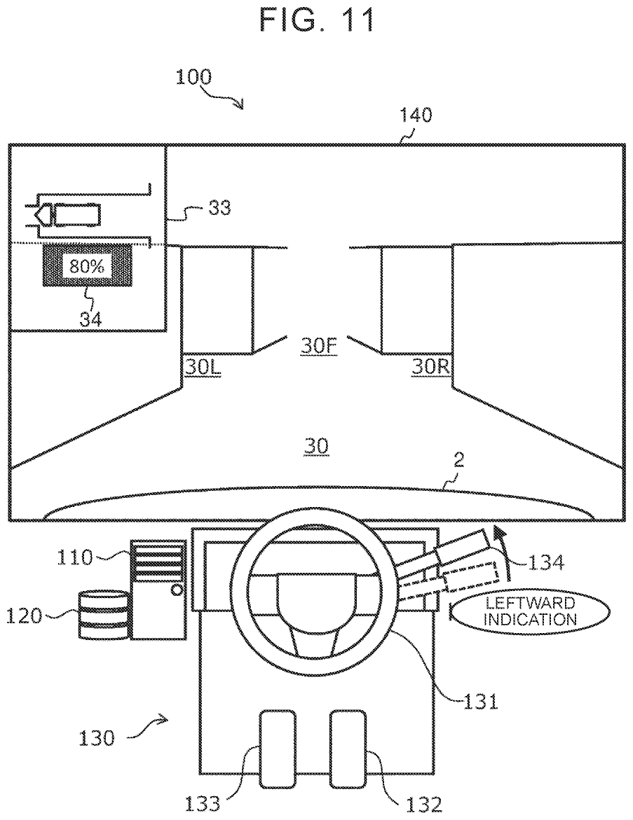

FIG. 11 shows a display example of the screen of the display device 140 in the third case. Here, the turn signal 134 is operated to the left by the remote driver before the vehicle 2 reaches the junction. In the display example shown in FIG. 11, the plan view is displayed in a window 33 provided in the screen. The window 33 is opened on the side designated by the turn signal 134, that is, the side for which the remote driver indicates intention to move as the traveling direction.

In the plan view in the window 33, the state of the road to which the remote driver is going to travel, that is, the leftward road 30L is displayed. Further, the simulation result of the possible traveling locus of the vehicle 2 is displayed. The simulation result supports the remote driver to accurately understand the state of the leftward road 30L.

Further, in the window 33, an indicator 34 indicating the degree of margin of the road width with respect to the vehicle width is displayed. The position where the indicator 34 is displayed is near the point at which the road is narrowest in the plan view, and the degree of margin at that point is calculated. The display color of the indicator 34 changes corresponding to the degree of margin, and the numerical value of the degree of margin is displayed in the indicator 34. In the example shown in FIG. 11, since the degree of margin is 80%, the display color of the indicator 34 is red. With the above, the remote driver can understand that the vehicle 2 cannot pass through the leftward road 30L before the vehicle 2 turns left at the junction.

### 3. Procedure of Support Method

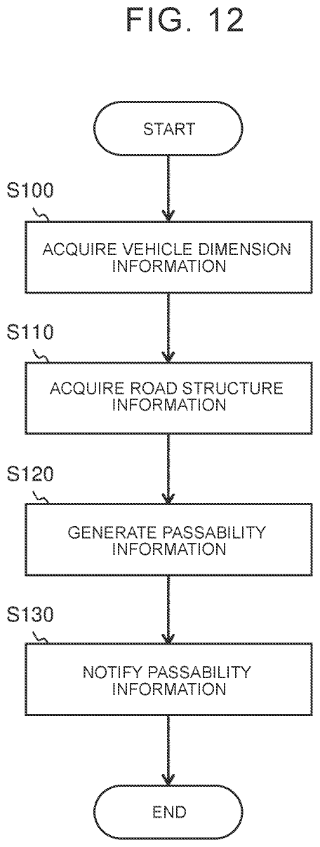

As is clear from the explanation of the above specific cases, the support method according to the present embodiment generates the passability information from the vehicle dimension information and the road structure information, and notifies the remote driver of the information. The procedure of the support method according to the present embodiment is comprehensively shown by the flowchart in FIG. 12.

According to the flowchart in FIG. 12, in step S100, the vehicle dimension information related to the dimensions of the vehicle 2 that is remotely driven by the remote driver is acquired. The vehicle dimension information may be acquired from the on-board control device of the vehicle 2 or may be acquired from the data server on the network.

Next, in step S110, the road structure information related to the structure of the road ahead to which the vehicle 2 is heading is acquired. The road structure information can be acquired from the high-precision three-dimensional map data. However, the road structure information may also be acquired by the environment recognition sensor such as the camera. Note that, the acquisition of the vehicle dimension information in step S100 may be after or at the same time as the acquisition of the road structure information in step S110.

Next, in step S120, the passability information related to the possibility that the vehicle 2 can pass through the road ahead is generated based on the vehicle dimension information and the road structure information. One specific example of the passability information is the degree of margin of the dimension of the road ahead with respect to the dimension of the vehicle 2. In the above-mentioned specific case, the degree of margin of the road dimension with respect to the vehicle width is calculated. However, depending on the road structure, a degree of margin of the ceiling height of a tunnel section with respect to the vehicle height and a degree of margin of the step height with respect to the minimum ground clearance may also be calculated.

Then, in step S130, the remote driver is notified of the passability information. In the above-mentioned specific case, the indicator is displayed on the screen of the display device 140, the display color of the indicator is changed corresponding to the degree of margin, and the degree of margin is displayed numerically. However, as a method of notifying the remote driver of the passability information, when the vehicle 2 cannot pass through the road ahead, a warning by sound or vibration of the steering wheel or the seat may be used in combination with the indicator.

The passability information notified to the remote driver by executing the support method according to the present embodiment is information useful for determining whether the vehicle 2 can pass though the road ahead. With the support method according to the present embodiment, it is possible to support the remote driver by providing the useful information.

### 4. Configuration of Support System

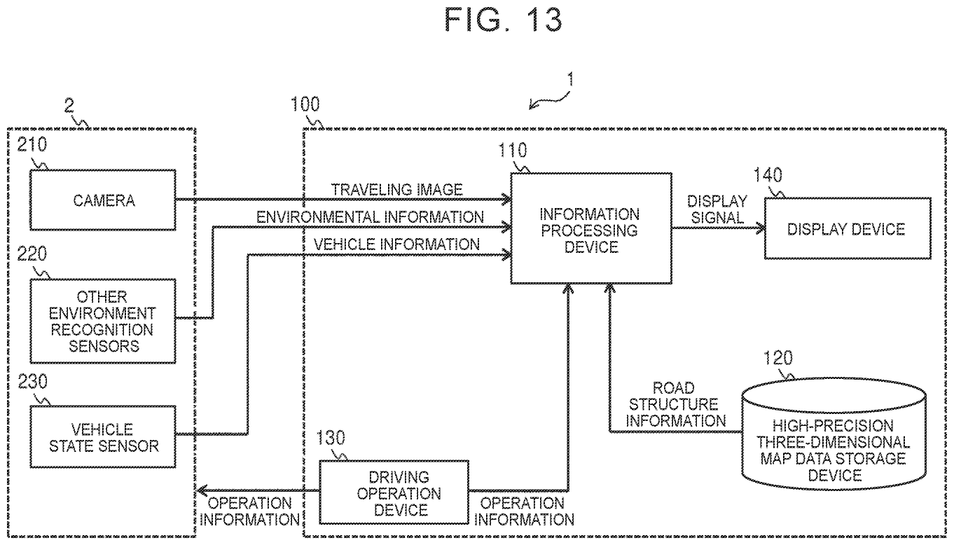

The support method according to the present embodiment is executed using, for example, a support system having the configuration shown in FIG. 13. Hereinafter, the configuration of a support system 1 according to the present embodiment will be described. However, components that overlap with the above-mentioned contents will be omitted as appropriate.

The support system 1 includes a camera 210 mounted on the vehicle 2. The camera 210 captures and outputs a traveling image of the vehicle 2. The traveling image output by the camera 210 is transmitted to the information processing device 110. The camera 210 may include a plurality of cameras that captures traveling images in a plurality of directions.

The camera 210 is one of the environment recognition sensors for recognizing the surrounding environment of the vehicle 2. The support system 1 includes a plurality of types of environment recognition sensors 220 in addition to the camera 210. Other environment recognition sensors 220 include, for example, LIDAR and a millimeter wave radar. The environmental information obtained by the environment recognition sensors 220 is transmitted to the information processing device 110.

The support system 1 includes a vehicle state sensor 230 that acquires information on the state of the vehicle 2, for example, a vehicle speed, deceleration, lateral acceleration, a yaw rate, and the like. The vehicle state sensor 230 includes, for example, a wheel speed sensor, an acceleration sensor, a gyro sensor, and the like. The vehicle information acquired by the vehicle state sensor 230 is transmitted to the information processing device 110.

The support system 1 includes the driving operation device 130. The driving operation device 130 receives a driving operation by the remote driver and outputs the operation information. The operation information output by the driving operation device 130 is transmitted to the vehicle 2 and the information processing device 110. When the vehicle 2 travels in accordance with the operation information by the on-board control device (not shown), remote driving by the remote driver is realized.

The information processing device 110 executes processing based on the acquired information, generates the display signal, and outputs the display signal to the display device 140. The information acquired by the information processing device 110 includes the road structure information acquired from the data storage device 120 that stores the high-precision three-dimensional map data. The process shown in the flowchart in FIG. 12 is executed by the information processing device 110. That is, the support method according to the present embodiment is executed as the information processing device 110 executes the process shown in the flowchart in FIG. 12.

What is claimed is:

1. A remote driver support method comprising:
acquiring vehicle dimension information related to a dimension of a vehicle that is remotely driven by a remote driver;
acquiring road structure information related to a structure of a road ahead to which the vehicle is heading;
generating passability information related to a possibility that the vehicle is able to pass through the road ahead based on the vehicle dimension information and the road structure information; and
notifying the remote driver of the passability information.

2. The remote driver support method according to claim 1, further comprising notifying the remote driver of the vehicle dimension information and the road structure information together with the passability information.

3. The remote driver support method according to claim 1, wherein the notifying the remote driver of the passability information includes changing a color of at least a part of a screen viewed by the remote driver corresponding to a magnitude of passability.

4. The remote driver support method according to claim 1, wherein the notifying the remote driver of the passability information includes numerically displaying a degree of margin of a dimension of the road ahead with respect to the dimension of the vehicle on a screen viewed by the remote driver.

5. The remote driver support method according to claim 1, further comprising selecting the road ahead from among a plurality of roads in accordance with an operation direction of a turn signal by the remote driver.

6. The remote driver support method according to claim 1, further comprising:
displaying a view in front of the vehicle on a screen viewed by the remote driver; and
displaying an image showing the dimension of the vehicle on the screen.

7. The remote driver support method according to claim 1, further comprising:
displaying an image of the road ahead in a plan view or in a bird's-eye view on a screen viewed by the remote driver; and
displaying an image showing a simulation result of a possible traveling locus of the vehicle on the image of the road ahead.

8. The remote driver support method according to claim 1, wherein the acquiring the road structure information includes acquiring the road structure information from high-precision three-dimensional map data.

9. The remote driver support method according to claim 1, wherein the acquiring the road structure information includes acquiring the road structure information using an environment recognition sensor mounted on the vehicle.

10. A remote driver support system comprising:
at least one memory that stores at least one program; and
at least one processor connected to the at least one memory; wherein the at least one program is configured to cause the at least one processor to
acquire vehicle dimension information related to a dimension of a vehicle that is remotely driven by a remote driver,
acquire road structure information related to a structure of a road ahead to which the vehicle is heading,
generate passability information related to a possibility that the vehicle is able to pass through the road ahead based on the vehicle dimension information and the road structure information, and
notify the remote driver of the passability information.

11. A non-transitory storage medium storing a program that causes a computer to execute support of a remote driver and causes the computer to:
acquire vehicle dimension information related to a dimension of a vehicle that is remotely driven by the remote driver;
acquire road structure information related to a structure of a road ahead to which the vehicle is heading;
generate passability information related to a possibility that the vehicle is able to pass through the road ahead based on the vehicle dimension information and the road structure information; and
notify the remote driver of the passability information.
